(19) United States
(12) Patent Application Publication
(10) Pub. No.: US 2009/0106661 A1
(43) Pub. Date: Apr. 23, 2009

(54) Switching System and Method for Display Interface

(75) Inventors: Hai-Yen Sung, Tianjin (CN); Tom Chen, Taipei (CN); Win-Harn Liu, Taipei (TW)

Correspondence Address: APEX JURIS, PLLC, 12733 LAKE CITY WAY NORTHEAST, SEATTLE, WA, 98125, US

(73) Assignee: INVENTEC CORPORATION, Taipei (TW)

(21) Appl. No.: 11/874,018

(22) Filed: Oct. 17, 2007

(51) Int. Cl. G06F 15/177

(52) U.S. Cl. 715/738

(57) ABSTRACT

A switching system and method for a display interface is relative to the system including an interface switching program, a data display interface, and an index database. The interface switching program has a text input box and a toggle button, for a user to type a keyword and then click the toggle button to trigger an interface switching event. The data display interface is for the user to browse a data. The index database stores a correspondence table of the keyword and a string data. The interface switching program queries the index database according to the interface switching event, so as to acquire a string data, and controls the data display interface to automatically display a data corresponding to the string data, so as to achieve the switch of display interface through the keyword, thereby improving the operating convenience.

### BACKGROUND OF THE INVENTION

1. Field of Invention

The present invention relates to an interface switching system and method. More particularly, the present invention relates to a switching system and method for a display interface.

2. Related Art

Display interfaces are widely used in searching and displaying electronic documents. For web browsing interfaces, electronic documents are stored in a computer server connected to Internet in the form of the hypertext markup language (HTML) format files. A computer user can retrieve the HTML format files by accessing the internet.

Currently, during a web browsing operation, when the user wants to switch to a specific web page, or view a specific function in the web, he/she enters a web page mostly by clicking options in the function list or links. If the user is not familiar with the specific web browsing interface or the specific function, he/she will spend more unnecessary time in searching the function list or the links, thus lowering the operation efficiency of the user, and reducing the availability of the product. Moreover, different products have different corresponding functions, and the designs of the function list or the links are quite different, which increases the user's operation, and meanwhile cannot guide the user to use the function on the web very well.

Furthermore, during a normal data search, the user always finds a specific file or browses a specific data through opening folders in a tree structure in turn, so if the folders in the tree structure become more complex, the operation steps of the user increase, resulting in inconvenience.

Therefore, researchers are in urgent need of finding solutions to provide a display interface capable of being operated conveniently.

### SUMMARY OF THE INVENTION

In view of the above problems, the present invention provides a switching system and method for a display interface, which are applicable to a web browsing interface or a data display interface. By typing a keyword in an interface switching program by a user, the interface switching program controls the display interface to automatically start and display a data corresponding to the keyword, thereby improving the operating convenience of the display interface.

The switching system for a web browsing interface of the present invention includes a client and a server. The client includes an interface switching program, having a text input box and a toggle button, provided for the user to type a keyword and then click the toggle button to trigger an interface switching event, and a web browsing interface, provided for a user to browse a web page. The server includes an index database, storing a correspondence table of the keyword and a string data, and a service program, resolving a request sent by the client, so as to execute a program corresponding to the request. When the interface switching program of the client transmits an interface switching request to the server according to the interface switching event, the service program of the server queries the index database according to the interface switching request, so as to acquire a string data and transmit the string data back to the interface switching program of the client. The interface switching program of the client converts the string data into a web page address, and the interface switching program of the client controls the web browsing interface to automatically display the web page corresponding to the web page address.

The switching method for a web browsing interface of the present invention includes the following steps. Firstly, an index database is created at the server, and the index database stores the correspondence table of the keyword and a string data. An interface switching program is installed at the client, and the interface switching program has a text input box and a toggle button, for the user to type a keyword and then click the toggle button to trigger an interface switching event. The interface switching program of the client transmits an interface switching request to the server according to the interface switching event. The server queries the index database according to the interface switching request, so as to acquire the string data and transmit the string data back to the interface switching program of the client. The interface switching program of the client converts the string data into a web page address. And, the interface switching program of the client controls the web browsing interface to automatically display the web page corresponding to the web page address.

The switching system for a data display interface of the present invention includes an interface switching program, having a text input box and a toggle button, for a user to type a keyword and then click the toggle button to trigger an interface switching event; a data display interface, provided for the user to browse a data; and an index database, storing a correspondence table of the keyword and a string data. The interface switching program queries the index database according to the interface switching event so as to acquire the string data, and controls the data display interface to automatically display a data corresponding to the string data.

According to the switching system and method for a display interface, after the user types the keyword in the interface switching program through the client, the interface switching program communicates with the server, so as to acquire a string data corresponding to the keyword. Then, the interface switching program opens a corresponding web page according to the string data. In such manner, the user can still easily open a browsing web page even though he dose not know the function list or the functions of the web browsing interface. Further, the user can define the keyword at will. The interface switching program communicates with the server according to the keyword defined by the user, so as to correlate and store the keyword and the web page address, so that the user can easily operate the web browsing interface according to his/her habit and confirmation, thereby improving the operating convenience of the web browsing interface. Additionally, the switching system and method of the present invention can also be applied in a data display interface in a data processing apparatus. Particularly, the manner of typing a keyword to directly open a specific data path improves the operating convenience.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a systematic block diagram of a first embodiment of the present invention;

FIG. 2 is a flow chart of steps of a switching method for a web browsing interface according to the first embodiment of the present invention;

FIG. 3 is a flow chart of steps of a correspondence table creating method according to the first embodiment of the present invention; and

FIG. 4 is a systematic block diagram of a second embodiment of the present invention.

### DETAILED DESCRIPTION OF THE INVENTION

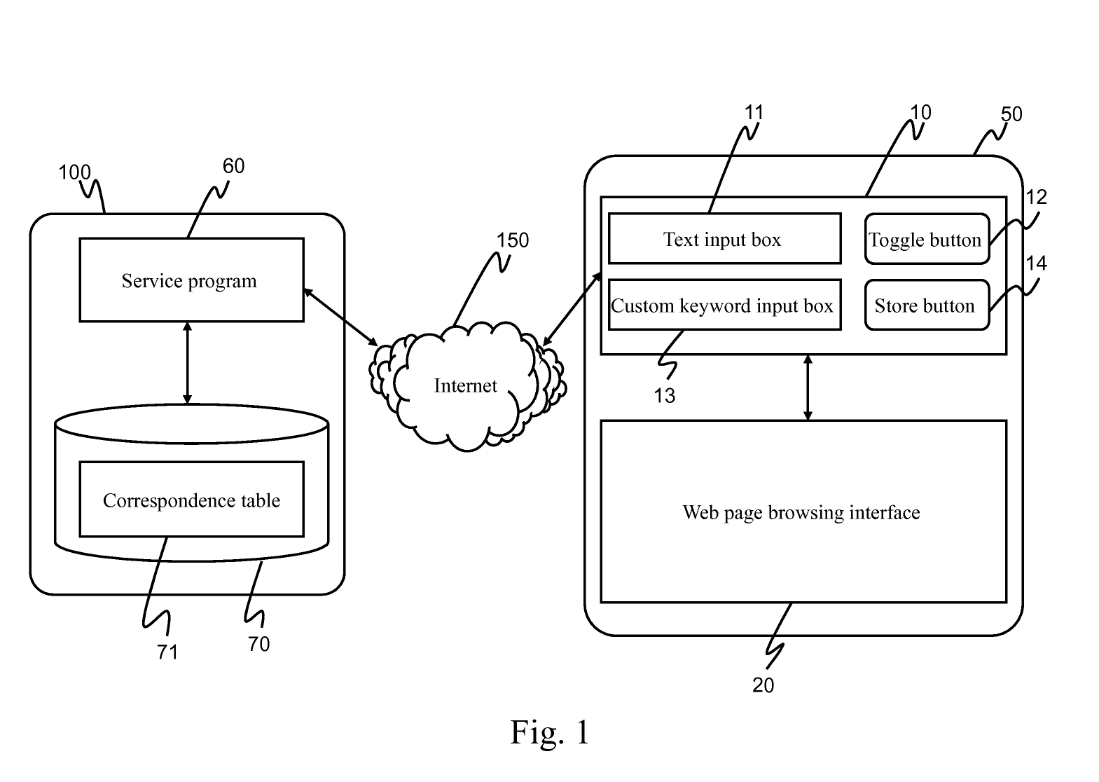

Referring to FIG. 1, a systematic block diagram of a first embodiment of the present invention is shown. As shown in FIG. 1, the switching system for a web browsing interface of the present invention includes a client 50 and a server 100, which are communicated with each other through an internet 150. The internet 150 may be, for example, a wired or wireless internet. Further, a web browsing interface is taken as an example in the first embodiment of the present invention, but the display interface is not limited to a web browsing interface.

The client 50 includes an interface switching program 10 and a web browsing interface 20, which are illustrated as follows.

The interface switching program 10 may be installed in a data processing apparatus, for example, computer, PDA, and mobile phone of the client 50. The interface switching program 10 has a graphical user interface (GUI) of a text input box 11 and a toggle button 12. The text input box 11 is provided for the user to type a keyword and then the user clicks the toggle button 12 to trigger an interface switching event. The interface switching program 10 further has a GUI of a custom keyword input box 13 and a store button 14. The custom keyword input box 13 is provided for the user to type a custom keyword and then the user clicks the store button 14 to trigger a keyword store event. Further, persons skilled in the art would appreciate that the user can also type the custom keyword the through the text input box 11 and click the store button 14 to trigger a keyword store event. In other words, the interface switching program 10 may omit the custom keyword input box 13, which is also within the scope of the present invention.

The web browsing interface 20, connected with the interface switching program 10, is provided for the user to browse a web page and controls the open and close or the open of a web page at a specific web page address through the interface switching program 10. The web browsing interface 20 may be a browser that supports HTML, for example, the Internet Explorer (IE) browser of Microsoft Company, the Navigator browser of Netscape Company, or the like.

The server 100 includes a service program 60 and an index database 70, which are illustrated as follows.

The service program 60 resolves the request sent by the client 50 so as to execute a program corresponding to the request. The program may, for example, store data, read data, query data, compare data, transmit data, or receive data, and so on.

The index database 70, connected with the service program 60, stores a correspondence table 71 of the keyword and a string data, and the keyword and the string data in the correspondence table 71 are in one-to-one correspondence.

When the interface switching program 10 of the client 50 transmits an interface switching request to the server 100 according to the interface switching event, the service program 60 of the server 100 queries the correspondence table 71 in the index database 70 according to the interface switching request, so as to acquire the string data and transmit the string data back to the interface switching program 10 of the client 50. Next, the interface switching program 10 of the client 50 converts the string data into a web page address, and the interface switching program 10 controls the web browsing interface 20 to display a web page corresponding to the web page address. The interface switching request includes the keyword.

When the interface switching program 10 of the client 50 transmits a keyword store request to the server 100 according to the keyword store event, the service program 60 of the server 100 correlates the custom keyword and the string data according to the keyword store request and stores into the correspondence table 71. The keyword store request includes the custom keyword and a web page address opened by the current web browsing interface 20.

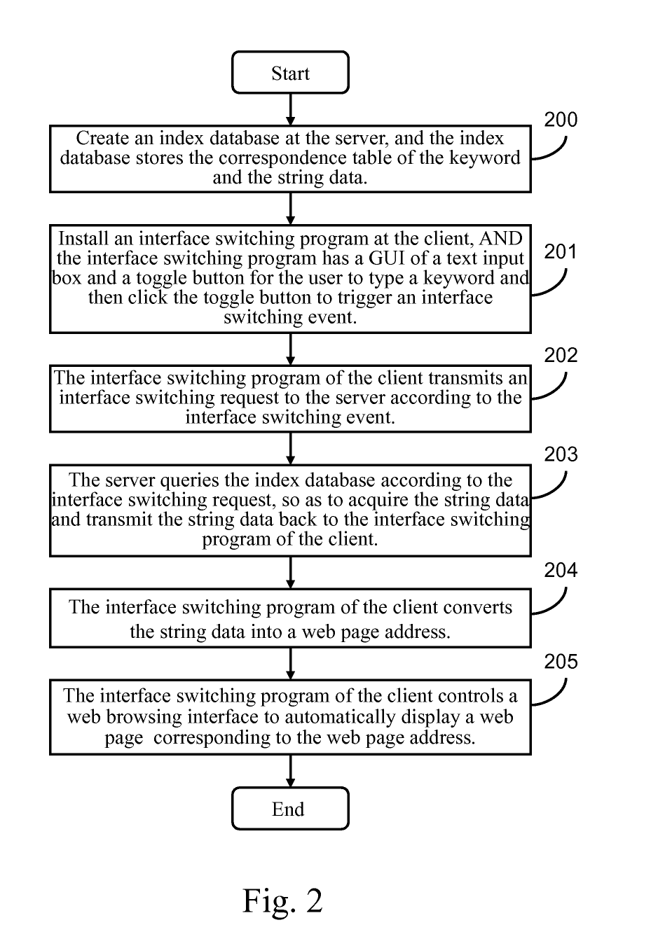

Referring to FIG. 2, it is a flow chart of steps of a switching method for a web browsing interface according to the first embodiment of the present invention. As shown in FIG. 2, the switching method for a web browsing interface of the present invention includes the following steps.

Firstly, an index database is created at the server. The index database stores the correspondence table of the keyword and the string data (Step 200), and the keyword and the string data in the correspondence table are in one-to-one correspondence.

An interface switching program is installed at the client. The interface switching program has a GUI of a text input box and a toggle button for the user to type a keyword and then click the toggle button to trigger an interface switching event (Step 201).

The interface switching program of the client transmits an interface switching request to the server according to the interface switching event over the internet (Step 202). The interface switching request includes the keyword.

The server queries the index database according to the interface switching request, so as to acquire the string data and transmit the string data back to the interface switching program of the client over the internet (Step 203). The server has a service program to resolve the interface switching request, so as to acquire the keyword, and the service program queries the correspondence table according to the obtained keyword, so as to acquire the string data.

The interface switching program of the client converts the string data into a web page address (Step 204). The interface switching program converts the string data into a web page address according to pre-defined conversion rules.

The interface switching program of the client controls a web browsing interface to open the web page address and to display a web page corresponding to the web page address (Step 205).

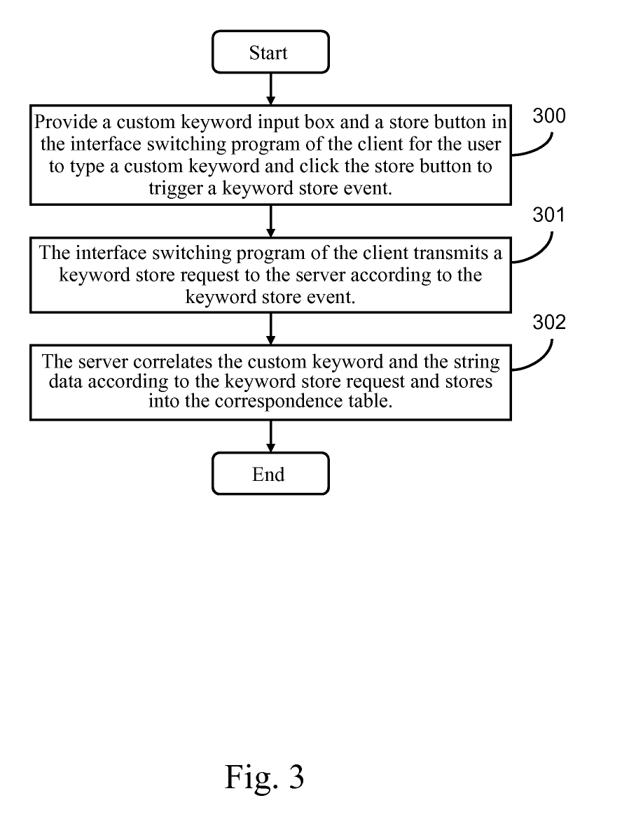

Referring to FIG. 3, a flow chart of steps of a correspondence table creating method according to the first embodiment of the present invention is shown. As shown in FIG. 3, the correspondence table creating method of the present invention includes the following steps. After the user at the client opens a web page address through a web browsing interface, the service program of the server acquires the web page address of the client, and performs an operation of correlating the keyword and the string data. The web page address includes the string data and communication protocol format information. The method of creating the correspondence table includes the following steps.

Firstly, a custom keyword input box and a store button are provided in the interface switching program of the client for the user to type a custom keyword and then click the store button so as to trigger a keyword store event (Step 300).

The interface switching program of the client transmits a keyword store request to the server according to the keyword store event over the internet (Step 301). The keyword store request includes the custom keyword and the current web page address.

The server correlates the custom keyword and the string data according to the keyword store request and stores into the correspondence table (Step 302). A batch of string data corresponds to one web page address.

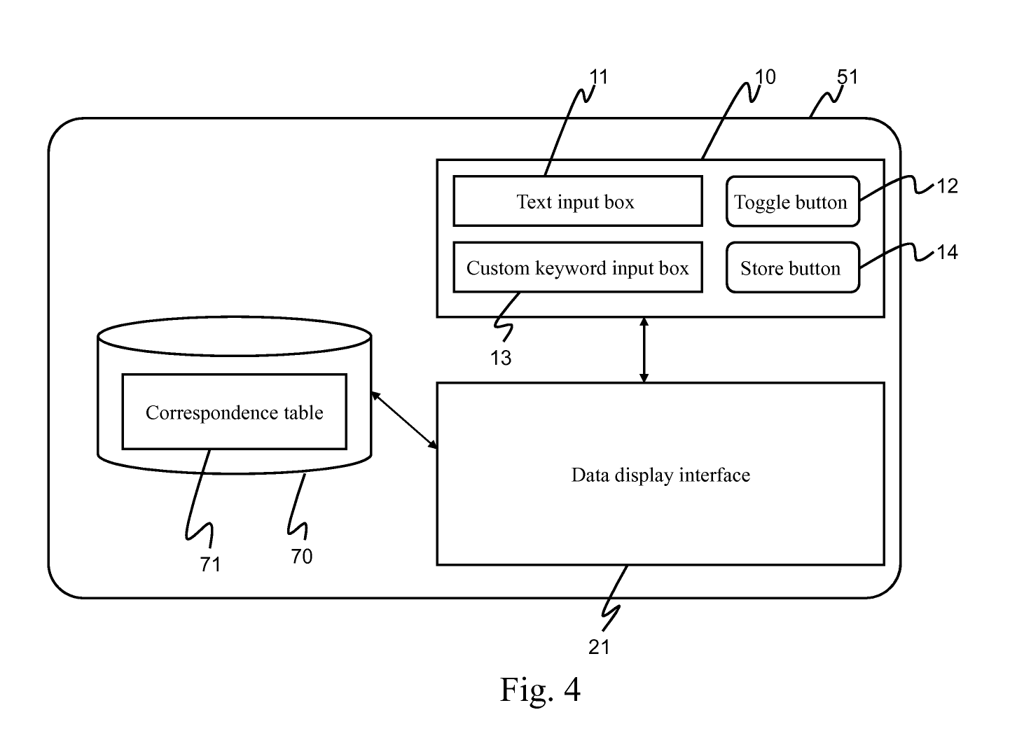

Referring to FIG. 4, a systematic block diagram of a second embodiment of the present invention is shown. As shown in FIG. 4, a switching system 51 includes an interface switching program 10, a data display interface 21, and an index database 70.

The interface switching program 10 may be installed in a data processing apparatus, for example, computer, PDA, and mobile phone. The interface switching program 10 has a GUI of a text input box 11 and a toggle button 12. The text input box 11 is provided for the user to type a keyword, and then the user click the toggle button 12 to trigger an interface switching event. The interface switching program 10 further has a GUI of a custom keyword input box 13 and a store button 14. The custom keyword input box 13 is provided for the user to type a custom keyword, and then the user click the store button 14 to trigger a keyword store event. Furthermore, persons skilled in the art would appreciate that the user may type the custom keyword through the text input box 11 and click the store button 14 to trigger a keyword store event. In other words, the interface switching program 10 can omit the custom keyword input box 13, which is also within the scope of the present invention.

The data display interface 21, connected with the interface switching program 10, is provided for the user to browse a data and controls the open and close or the open of a data of a specific data path through the interface switching program 10. The data display interface 21 may be an electronic phone directory operation interface or a data search operation interface, or the like.

The index database 70 stores a correspondence table 71 of the keyword and a string data, and the keyword and the string data in the correspondence table 71 are in one-to-one correspondence. The interface switching program 10 queries the index database 70 according to the interface switching event so as to acquire the string data, and controls the data display interface 21 to automatically display a data corresponding to the string data.

Furthermore, the creating method of the correspondence table 71, for example, may include the following steps. A custom keyword input box 13 and a store button 14 are provided in the interface switching program 10 for the user to type the custom keyword and click the store button 14 to trigger a keyword store event. Next, the interface switching program 10 correlates the custom keyword and the string data according to the keyword store event and stores into the correspondence table 71.

In view of the above, in the switching system and method for a display interface of the present invention, after the user at the client types the keyword into the interface switching program, the interface switching program communicates with the server, so as to acquire the string data corresponding to the keyword. Then, the interface switching program opens a corresponding web page according to the string data. In other words, the switching system and method of the present invention are equivalent to setting a shortcut function on a web accessing path for the user to quickly open a browsing web, even if he/she is not familiar with the function list of the internet browsing interface. Therefore, the operating convenience of the web browsing interface is improved. Furthermore, the witching system and method of the present invention can also be applied in a data display interface in a data processing apparatus. Particularly, the manner of typing a keyword to directly open a specific data path improves the operating convenience.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A switching system for a web browsing interface, comprising:
a client, comprising:
an interface switching program, having a text input box and a toggle button, for a user to type a keyword and then click the toggle button to trigger an interface switching event; and
a web browsing interface, provided for a user to browse a web page;
a server, comprising:
an index database, storing a correspondence table of the keyword and a string data; and
a service program, for resolving a request sent by the client, so as to execute a program corresponding to the request;
wherein the interface switching program of the client transmits an interface switching request to the server according to the interface switching event; the service program of the server queries the index database according to the interface switching request, so as to acquire the string data and transmit the string data back to the interface switching program of the client; the interface switching program of the client converts the string data into a web page address; and the interface switching program of the client controls the web browsing interface to automatically display a web page corresponding to the web page address.

2. The switching system for a web browsing interface as claimed in claim 1, wherein the correspondence table further comprises the following creating steps:
providing a custom keyword input box and a store button in the interface switching program of the client, for the user to type a custom keyword and then click the store button to trigger a keyword store event;
the interface switching program of the client transmitting a keyword store request to the server according the keyword store event; and
the service program of the server correlating the custom keyword and the string data according to the keyword store request, and storing into the correspondence table.

3. The switching system for a web browsing interface as claimed in claim 2, wherein the keyword store request comprises the custom keyword and the current web page address.

4. The switching system for a web browsing interface as claimed in claim 1, wherein the interface switching request comprises the keyword.

5. A switching method for a web browsing interface, comprising:
creating an index database at a server, wherein the index database stores a correspondence table of a keyword and a string data;
installing an interface switching program at a client, wherein the interface switching program has a text input box and a toggle button, for a user to type a keyword and then click the toggle button to trigger an interface switching event;
the interface switching program of the client transmitting an interface switching request to the server according to the interface switching event;
the server querying the index database according to the interface switching request, so as to acquire the string data and transmit the string data back to the interface switching program of the client;
the interface switching program of the client converting the string data into a web page address; and
the interface switching program of the client controlling a web browsing interface to automatically display a web page corresponding to the web page address.

6. The switching method for a web browsing interface as claimed in claim 5, wherein the correspondence table further comprises the following creating steps:
providing a custom keyword input box and a store button in the interface switching program of the client, for the user to type a custom keyword and then click the store button to trigger a keyword store event;
the interface switching program of the client transmitting a keyword store request to the server according to the keyword store event; and
the server correlating the custom keyword and the string data according to the keyword store request, and storing into the correspondence table.

7. The switching method for a web browsing interface as claimed in claim 6, wherein the keyword store request comprises the custom keyword and the current web page address.

8. The switching method for a web browsing interface as claimed in claim 5, wherein the interface switching request comprises the keyword.

9. A switching system for a data display interface, comprising:
an interface switching program, having a text input box and a toggle button, for a user to type a keyword and then click the toggle button to trigger an interface switching event;
a data display interface, provided for the user to browse a data; and
an index database, storing a correspondence table of the keyword and a string data;
wherein the interface switching program queries the index database according to the interface switching event, so as to acquire the string data, and controls the data browsing interface to automatically display the data corresponding to the string data.

10. The switching system for a data display interface as claimed in claim 9, wherein the correspondence table further comprises the following creating steps:
providing a custom keyword input box and a store button in the interface switching program of the client, for the user to type a custom keyword and then click the store button to trigger a keyword store event; and
the interface switching program correlating the custom keyword and the string data according to the keyword store event, and storing into the correspondence table.
